(19) United States
(12) Patent Application Publication
(10) Pub. No.: US 2008/0143242 A1
(43) Pub. Date: Jun. 19, 2008

(54) Light Emitting Device Comprising Inorganic Light Emitting Diode (S)

(75) Inventors: Jan De Graaf, Eindhoven (NL); Hans Van Sprang, Eindhoven (NL); Marcus Antonius Verschuuren, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/816,104

(22) PCT Filed: Feb. 7, 2006
(86) PCT No.: PCT/IB06/50393

§ 371 Date: Aug. 13, 2007

(30) Foreign Application Priority Data
Feb. 16, 2005 (EP) 05101163.3

(51) Int. Cl. H01J 1/62; H01J 9/02

(52) U.S. Cl. 313/498; 445/50

(57) ABSTRACT

The present invention relates to a light emitting device (10) comprising at least one inorganic light emitting diode (LED) (14) for emitting primary light, a luminescent plate (12) supporting on a first side the LED(s), which plate is adapted to convert the wavelength of at least part of said primary light from the LED(s), and light scattering means for coupling out light from the luminescent plate. The invention makes it possible to omit any bulky extraction optics, and allows for a flat and compact LED module design. The present invention also relates to a method for the manufacture of such a light emitting device.

The present inventions relates to light emitting device comprising at least one inorganic light emitting diode (LED). The present invention also relates to a method for the manufacture of such a light emitting device.

There are many examples of light emitting devices, which comprise inorganic light emitting diodes (LEDs) or organic light emitting diodes (OLEDs). However, organic light emitting devices, which are used in for example displays, are limited in the applied power per area and therefore in the emitted flux per area. This is due to failure mechanisms in the materials of the devices at higher loads. Inorganic LEDs on the other hand have superior properties in this respect over organic light emitting devices. In this context, the present invention relates to a light emitting device using inorganic LEDs.

There is currently a market for light emitting devices which generate white light by using blue or UV(A) inorganic LEDs in combination with luminescent materials, the so called phosphor converted LEDs. Typically, a blue LED chips is coated or covered with a phosphor that converts at least some of the blue radiation to for example yellow light. Together, the non-converted blue light and the yellow light generates a white light.

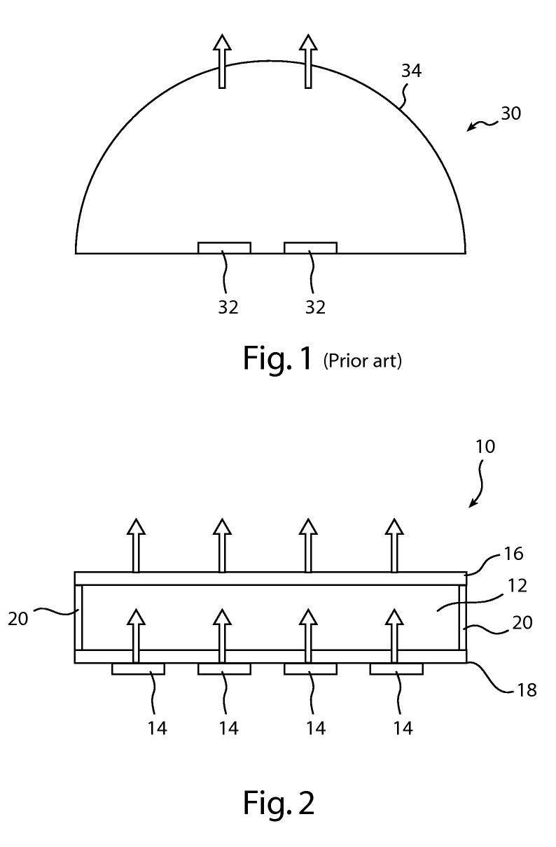

Light extraction is a key issue for these light emitting devices. A classical approach of extracting light from phosphor converted LEDs involves the use of primary extraction optics, i.e. optical domes that extract the light based on their refractive properties. FIG. 1 schematically shows such a light emitting device 30 having a plurality of LEDs 32 covered by a single dome 34. However, a disadvantage of this approach is that light is extracted at the expense of compactness of the light emitting device or LED module. This is because light emitted far off center of the dome can be trapped inside the dome due to total internal reflection, wherefore the hemispherical dome must have a diameter which is substantially larger than the light emitting area (i.e. the base area of the dome is substantially larger than the LED or LEDs), which in turn also results in a dome having considerable height. This applies in particular to multi-chip LED modules where one single optical dome is used to cover a plurality of LEDs.

Furthermore, the current primary extraction optics have limited photo-thermal stability, which limits the power of the used LEDs and consequently the lumen power of the light emitting device.

It is an object of the present invention to overcome these problems, and to provide an improved and compact light emitting device using inorganic LEDs.

This and other objects that will be evident from the following description are achieved by means of a light emitting device, and a method for the manufacture of such a light emitting device, according to the appended claims.

According to an aspect of the invention, there is provided a light emitting device comprising at least one inorganic light emitting diode (LED) for emitting primary light, a luminescent plate supporting on a first side the LED(s), which plate is adapted to convert the wavelength of at least part of said primary light from the LED(s), and light scattering means, for coupling out light from the luminescent plate.

The light scattering means enables extraction of light that otherwise would undergo total internal reflection. The light scattering means can be a photon randomization layer provided on a second side of the luminescent plate, which second side is opposite to the first side. Alternatively, the light scattering means can be light scattering particles incorporated in the luminescent plate. Both alternatives allow for efficient light extraction without using any bulky primary extraction optics, and provide for a flat optical layout with significantly reduced height compared to prior art extraction optics. Further, the LED(s) can be placed anywhere on the surface of the luminescent plate with maintained light extraction. Thus, the area of the plate does not have to be substantially larger than the LED(s), which allows for a compact LED module design. Also, a plurality of LEDs can be mounted on the plate with a high packing density, resulting in a compact high brightness multi-LED module.

In another embodiment of the invention, the light emitting device further comprises a dichroic mirror interposed between the luminescent plate and the LED(s), which dichroic mirror is adapted to transmit the primary light and reflect converted light. The dichroic mirror offers the advantage of preventing light losses at the first side (the backside) of the luminescent plate and directs all converted light forward towards the second side (the front side or emissive side) of the luminescent plate. This results in efficient light extraction and increased brightness.

In another embodiment of the invention, the light emitting device further comprises reflective mirrors arranged on the side walls of the luminescent plate. These reflective mirrors prevent light from escaping through the side walls of the luminescent plate, whereby light losses are decreased. The reflective mirrors can for example be dichroic mirrors or metallic reflective mirrors.

The light emitting diode(s) can be adapted to emit one of blue light and UV(A) light. In the former case, part of the blue light emitted from the LEDs into the luminescent plate is converted into for example yellow light, while part of the blue light is emitted through the scattering means and adds up to the yellow light, resulting in white light. In the latter case, all UV(A) is converted and emitted from the front side through the scattering means.

The luminescent plate can comprise inorganic encapsulated phosphors. The use of inorganic encapsulated phosphors provides for high photo-thermal stability. This allows for the device to be resistant to high temperatures, which in turn enables the use of high power LED chips. High power LED chips contribute to high lumen output of the light emitting device. This of course assumes that the remaining material of the plate also can withstand the load generated by a plurality of high power LED chips. Such a plate can for example be polycrystalline. A polycrystalline plate also allows manufacture by ceramic powder shaping and sintering.

According to another aspect of the invention, a method for the manufacture of a light emitting device is provided, which method comprises providing a luminescent plate, arrange at least one inorganic light emitting diode at a first side of the plate, and applying scattering means to the plate. This method offers similar advantages as obtained with the previously discussed aspect of the invention.

These and other aspects of the present invention will now be described in more detail, with reference to the appended drawings showing a currently preferred embodiment of the invention.

FIG. 1 is a side view of a light emitting device according to prior art, and

FIG. 2 is a side view of a light emitting device according to an embodiment of the invention.

FIG. 2 shows a light emitting device 10 according to an embodiment of the invention. The light emitting device 10 can for example be used for illumination purposes. The light emitting device 10 comprises a luminescent plate 12 supporting a plurality of inorganic light emitting diodes (LEDs) 14. Thus, the plate 12 functions as a substrate for the LEDs 14.

The luminescent plate 12 can be transparent or translucent, and is luminescent upon blue or UV radiation due to encapsulated inorganic phosphors. The luminescent plate 12 is preferably polycrystalline. For example, it can be made of a monolith luminescent ceramic or a ceramic phosphor composite. Alternatively, it can be made of for example a glass having incorporated luminescent functionality. Such plates as mentioned above can withstand the high loads that arise when the plate is coupled to a plurality of inorganic LEDs.

The LEDs 14 can be LEDs emitting blue light or UV(A) light or radiation (“primary light”). The LEDs can comprise sapphire wafer substrates with InGaN material processed thereon.

The light emitting device 10 further comprises a photon randomizing layer 16 arranged on the opposite side of the luminescent plate 12 in relation to the side supporting the LEDs 14. The photon randomizing layer 16 comprises a sub wavelength non-periodic randomized topology that has a light scattering function. The topology is “sub wavelength” in the sense that its features and/or irregularities are smaller than the wavelength of the light emitted by the chosen light source. The photon randomizing layer 16 can for example be achieved by applying a particle coating on the plate 12 or by embossing transparent thick films of a ceramic or sol-gel type on the plate 12.

Preferably, the light emitting device 10 further comprises a dichroic mirror 18 interposed between the luminescent plate 12 and the LEDs 14, and reflective mirrors 20 arranged on the side walls of the luminescent plate 12. The dichroic mirror 18 is transmissive for blue or UV light, and reflective for higher wavelengths. The dichroic mirror 18 can for example be achieved by coating the plate 12 using thin film deposition techniques. The LEDs 14 are optically coupled to the dichroic mirror 18. The coupling between the LEDs 14 and the dichroic mirror 18 on the luminescent plate 12 can for example be achieved by contact bonding the mirror/plate to the sapphire substrates of the LEDs (before or after processing of the InGaN material on these substrates), or by glue bonding the LEDs to the mirror/plate using a suitable transparent adhesive.

Upon operation of the light emitting device 10, light emitted from the LEDs 14 is extracted through the dichroic mirror 18 into the luminescent plate 12. The blue or UV light is not affected by the dichroic mirror 18 since the dichroic mirror 18 is transmissive in blue or UV, as stated above. Light extracted into the luminescent plate 12 is then converted by the luminescent material of the luminescent plate 12 to higher wavelengths. All the light reaching the top surface of the luminescent plate 12 is scattered by the photon randomizing layer 16. Part of the light is coupled out of the plate 12 after scattering, and part of the light is scattered back into the plate 12. It should be noted that also light that would undergo total internal reflection without this layer is scattered, and coupled out of the plate 12 or scattered back into the plate 12.

In case of UV(A) LEDs, there is full conversion to longer wavelengths, and all converted light is emitted from the top surface of the luminescent plate 12 through the photon randomizing layer 16. In case of blue LEDs, part of the blue light is converted to yellow light, or other light having longer wavelengths. The properties of the luminescent plate 12 are chosen so that a part of the (unconverted) blue light escapes from the top surface of the plate 12 through the photon randomization layer 16 and adds up to the (converted) yellow light (or other longer wavelength light) in order to produce white light.

In both of the above cases, any converted light incoming towards the bottom surface of the luminescent plate 12 (such as the part of the light scattered back into the plate 12 by the photon randomization layer 16) is reflected by the dichroic mirror 18 and re-directed towards the top surface and the photon randomization layer 16. Thus, loss of light at the bottom surface of the luminescent plate 12 is prevented, and the light gets a second chance to escape through the top surface of the plate 12. This increases the light output and so the brightness and efficiency of the light emitting device 10. The reflective mirrors 20 prevent light from escaping from the side walls of the luminescent plate 12, which also increases the brightness of the light emitting device 10.

In an alternative embodiment of the light emitting device according to the present invention, light scattering particles can be incorporated in the luminescent plate 12. In this case, the photon randomizing layer 16 can be omitted.

It should be noted that the inventive arrangement with a flat optical layout makes it possible to place the LEDs 14 essentially all the way out to the side of the plate 12 with maintained light extraction. In comparison to a prior art LED module such as shown in FIG. 1, this allows for (a) a smaller size for a light emitting device comprising a given number of LEDs, and/or (b) a higher LED chips packing density for a light emitting device having a given area.

The person skilled in the art realizes that the present invention by no means is limited to the preferred embodiments described above. On the contrary, many modifications and variations are possible within the scope of the appended claims.

1. A light emitting device (10), comprising:
at least one inorganic light emitting diode (LED) (14) for emitting primary light,
a luminescent plate (12) supporting on a first side said LED(s), which plate is adapted to convert the wavelength of at least part of said primary light from said LED(s),
and light scattering means, for coupling out light from said luminescent plate.

2. A light emitting device according to claim 1, comprising a plurality of inorganic LEDs.

3. A light emitting device according to claim 1, wherein said light scattering means is a photon randomization layer (16) provided on a second side of said luminescent plate, which second side is opposite to said first side.

4. A light emitting device according to claim 1, wherein said light scattering means is light scattering particles incorporated in said luminescent plate.

5. A light emitting device according to claim 1, further comprising:
a dichroic mirror (18) interposed between said luminescent plate and said light emitting diode(s), which dichroic mirror is adapted to transmit said primary light and reflect converted light.

6. A light emitting device according to claim 1, further comprising:
reflective mirrors (20) arranged on the side walls of said luminescent plate.

7. A light emitting device according to claim 1, wherein said light emitting diode(s) is adapted to emit one of blue light and UV(A) light.

8. A light emitting device according to claim 1, wherein said luminescent plate comprises inorganic encapsulated phosphors.

9. A light emitting device according to claim 1, wherein said luminescent plate is polycrystalline.

10. A method for the manufacture of a light emitting device (10), comprising:
providing a luminescent plate (12),
arrange at least one inorganic light emitting diode (LED) (14) at a first side of said plate, and
applying scattering means to said luminescent plate.

11. A method according to claim 10, wherein applying scattering means to said luminescent plate comprises applying a photon randomization layer (16) on a second side of said luminescent plate, which second side is opposite to said first side.

12. A method according to claim 10, wherein applying scattering means to said luminescent plate comprises incorporating light scattering particles in said luminescent plate.

13. A method according to claim 10, further comprising:
applying a dichroic mirror (18) between said luminescent plate and said light emitting diode(s).

14. A method according to claim 10, further comprising:
applying reflective mirrors (20) on the side walls of said luminescent plate.

15. A method according to claim 10, wherein said luminescent plate is polycrystalline, and wherein said polycrystalline plate is manufactured by ceramic powder shaping and sintering.
